(19) United States
(12) Patent Application Publication
(10) Pub. No.: US 2022/0220768 A1
(43) Pub. Date: Jul. 14, 2022

(54) COATED POST

(71) Applicant: CLIPEX IP LIMITED, Road Town (VG)

(72) Inventor: Ashley Dean Olsson, Goulburn, NSW (AU)

(73) Assignee: CLIPEX IP LIMITED, Road Town (VG)

(21) Appl. No.: 17/614,498

(22) PCT Filed: May 26, 2020
(86) PCT No.: PCT/AU2020/050521

§ 371 Date: Nov. 26, 2021

(30) Foreign Application Priority Data
May 27, 2019 (AU) 2019901806

(51) Int. Cl. E04H 17/22; E04H 17/14; C23C 2/06; C23C 4/04

(52) U.S. Cl. CPC E04H 17/22; C23C 4/04; C23C 2/06; E04H 17/1426

(57) ABSTRACT

A method of extending the corrosion resistance of a ground anchoring region of a steel or alloy fence or trellis post already having a sacrificial coating or non-sacrificial coating along an entire length of the fence or trellis post, said method including the step of applying at least one additional coating to the ground anchoring region so as to extend the corrosion resistance of the ground anchoring region. The at least one additional coating can be a sacrificial coating and/or non-sacrificial coating.

### RELATED APPLICATIONS

This application claims priority of Australian patent application number 2019901806 filed 27 May 2019, the entire contents of which are incorporated herein by way of reference.

### TECHNICAL FIELD

This invention relates to a method of extending the corrosion resistance and working life of a metal post, such as a steel or alloy fence or trellis post, and to a post having extended corrosion resistance. In particular, in one embodiment, the invention concerns extending the corrosion resistance of a ground anchoring region of a steel fence post.

### BACKGROUND

It is standard industry practice to galvanise agricultural steel fence posts or treat the steel with some other protective coating so as to minimise oxidation and rust formation, and to thereby extend the life of the post. Galvanised posts may also be further treated immediately after the hot galvanising process (passivation) so as to prevent the formation of zinc hydroxide on the surface of the galvanised fence post. Once galvanised and subjected to passivation, those fence posts are then usually sold as-is for commercial use.

A problem with these types of fence posts is that they have a limited working life and, in some installations, where specific ground conditions prevail, that life is significantly reduced due to the chemical composition of the ground and electrochemical reactions with the steel causing corrosion and degradation to the mechanical properties and performance of the fence post. It would be advantageous to extend that working life by providing extended corrosion resistance in an economically sustainable method.

It is well understood that the thickness of hot galvanised coatings on steel is limited by the chemical structure and thickness of the steel being used, and the chemical process that takes place between the molten zinc and the steel being treated during the process of hot galvanising, whereby regardless of the length of time the steel is immersed into the molten zinc bath or the number of times the process is repeated the thickness of the deposited zinc will reach a practical limit of approximately 10 mils or 250 microns. Hot galvanised coatings beyond this thickness suffer from brittleness and risk of de-lamination.

Agricultural fence posts are commonly no greater than 5 millimeters structural thickness at their thinnest cross-sectional measurement and are subject to deflection and vibration during their installation and use. Therefore, the practical limit of hot galvanising on traditional agricultural fence posts is between 55 microns and 120 microns. The expected life of a galvanised fence post below and above the ground is extremely difficult to state, with life expectancy greatly affected by the variations in soil and climatic conditions. It would be fair to say that a significant proportion of fences are replaced due to the failure of the ground anchoring region of the fence posts as a result of the corrosion present in the ground anchoring region of the post. It is unusual for a fence post to fail due to the corrosion that it has suffered above the ground anchoring region.

### SUMMARY OF INVENTION

The inventor has now discovered that the corrosion resistance of a ground anchoring region of a metal fence or trellis post, be it already treated with a non-sacrificial (passive/barrier) coating or sacrificial coating (such as galvanising), can be extended by applying over the exterior surface of the non-sacrificial (passive/barrier) coating or sacrificial coating (such as galvanising) at least one further coating to the ground anchoring region of the post, to slow down the rate of corrosion upon the ground anchoring region.

According to a first aspect of the present invention, there is provided a method of extending the corrosion resistance of a ground anchoring region of a steel or alloy post already having a sacrificial coating or non-sacrificial coating along an entire length of the post, said method comprising the step of applying at least one additional coating to the ground anchoring region so as to extend the corrosion resistance of the ground anchoring region.

According to a second aspect of the present invention, there is provided a method of extending the corrosion resistance of a ground anchoring region of a steel or alloy post, said method comprising the steps of:

applying a sacrificial coating or non-sacrificial coating along an entire length of the post; and

applying at least one additional coating to the ground anchoring region so as to extend the corrosion resistance of the ground anchoring region.

According to a third aspect of the present invention, there is provided a method of producing a coated steel or alloy post adapted to have extended corrosion resistance, said method comprising the step of applying at least one additional coating to a ground anchoring region of a steel or alloy post already having a sacrificial coating or non-sacrificial coating extending along an entire length of the post.

According to a fourth aspect of the present invention, there is provided a method of producing a coated steel or alloy post adapted to have extended corrosion resistance, said method comprising the steps of:

applying a sacrificial coating or non-sacrificial coating along an entire length of a steel or alloy post; and

applying at least one additional coating to a ground anchoring region of the post.

According to a fifth aspect of the present invention, there is provided a coated steel or alloy post when produced according to the method of the first, second, third or fourth aspect of the invention.

According to a sixth aspect of the present invention, there is provided a coated steel or alloy post having a sacrificial coating or non-sacrificial coating extending along an entire length of the post, and at least one additional coating applied to a ground anchoring region of the post.

According to a seventh aspect of the present invention, there is provided a coated steel or alloy post having a ground anchoring region and a non-ground anchoring region, wherein both the ground anchoring region and non-ground anchoring region are fully galvanised, and wherein the ground anchoring region comprises at least one additional coating that does not extend beyond the ground anchoring region or extends from the ground anchoring region partway along the non-ground anchoring region.

According to an eighth aspect of the present invention, there is provided a coated steel or alloy post having a ground anchoring region and a non-ground anchoring region, wherein both the ground anchoring region and non-ground anchoring region have a sacrificial coating or non-sacrificial coating, and wherein the ground anchoring region comprises at least one additional coating that does not extend beyond the ground anchoring region or extends from the ground anchoring region partway along the non-ground anchoring region.

It is to be appreciated that, when installing a post, a part of the non-ground anchoring region may also be extended into the ground. Hence, in practice, a part of the non-ground anchoring region may be taken as being part of the ground-anchoring region. For the sake of clarity, the post-member attachment points and regions will be referred to as being located within or on the non-ground anchoring region.

The sacrificial coating extending along an entire length of the post can be of any suitable nature. Examples of suitable sacrificial coatings include zinc, aluminium, zinc-aluminium alloy, zinc-nickel alloy, steel, titanium, copper, nickel, stainless steel, tin, nickel-chromium, acrylates, waxes, clear polymers and biopolymers.

In some embodiments, the sacrificial coating can comprise zinc that has bound metallurgically with the steel. (This is known as standard galvanisation.) In one embodiment, hot dipped galvanisation is used to produce the sacrificial coating, whereby the steel or alloy post is dipped into a zinc bath (eg. at a temperature of about 460° C.).

In some embodiments, the sacrificial coating can be applied by HVOF (High Velocity Oxy-Fuel Spraying), combustion flame spraying, plasma spraying, vacuum plasma spraying, or two wire electric arc spraying.

In some embodiments, the sacrificial coating extending along an entire length of the post can be a coating of zinc, aluminium or zinc-aluminium alloy, zinc-nickel alloy, steel, titanium, copper, nickel, stainless steel, tin, or nickel-chromium. These can be applied, for example, by spray transfer.

In some embodiments, the sacrificial coating can comprise zinc, aluminium or a zinc-aluminium alloy that has bound to the steel. This type of coating can be produced by thermal (arc or flame) spraying, for example.

The non-sacrificial coating/passive barrier extending along an entire length of the post can be of any suitable nature. Examples of non-sacrificial coatings/passive barriers include paints, epoxy resins, thermoplastics, bitumin or rubber coatings.

In some embodiments, a powder coating is applied electrostatically.

In some embodiments, a liquid coating is applied by way of a dipping step.

In some embodiments, the non-sacrificial coating can be a thermoplastic coating. The thermoplastic coating can combine corrosion and abrasion resistance. The thermoplastic coating can be applied as a liquid or powder.

Passive barrier protection works by coating the steel with a protective coating system that forms a tight barrier to prevent exposure to oxygen, water and salt (ions). The lower the permeability of the coating system to water, the better the protection provided. Two-pack epoxy coatings and chlorinated rubbers applied at sufficiently high film builds offer successful corrosion protection through passive barrier protection.

Active corrosion protection occurs when a primer containing a reactive chemical compound is applied directly to the steel. The reactive compound disrupts the normal formation of anodes on the surface of the steel in some way. For example, inorganic zinc inhibitive pigments, such as zinc phosphate, offer active anti-corrosive protection to the steel substrate (Zinc phosphate (Zn₃(PO₄)₂) is only slightly soluble in water). It hydrolyses in water to produce zinc ions (Zn²⁺) and phosphate ions (PO₄³⁻). The phosphate ions act as anodic inhibitors by phosphating the steel and rendering it passive. The zinc ions act as cathodic inhibitors.

The application of an organic coating, such as paint, is a cost-effective corrosion protection method. Organic coatings act as a barrier to a corrosive solution or electrolyte. They prevent, or retard, the transfer of electrochemical charge from the corrosive solution to the metal underneath the organic coating. The coating thickness of the auto-deposition film is time and temperature dependent. Initially, the deposition process is quite rapid, but slows down as the film begins to build or mature. As long as the part being coated is in the bath, the process will continue; however, the rate of deposition will decline.

Typically, film thicknesses are controlled from 15 to 25 micrometers (0.6 to 0.8 mils). Auto-deposition will coat any metal the liquid touches. Autodeposition does not require a phosphate stage and the coating is cured at a relatively low temperature.

In some embodiments, the non-sacrificial coating can be cold sprayed using high-speed jets of inert gas to speed up the finely powdered anti-corrosive material particles that are directed toward the surface of the part being coated. The particles deform plastically at a temperature that is lower than the melting temperature of metal. It is the technique of applying different metallic, composite and other powders, such as ceramic powders, to a metallic substrate by accelerating the powders to very high velocities (500 to 900 m/s). Upon impact onto the surface of the item being coated, the powdered particles readily deform and adhere to the surface to create a strong bond. Additional particles continue to impinge the solid surface, thus forming a thick coating.

Various combinations of corrosion resistant and wear resistant powders can be used for a given substrate in this technique. Composite cold coatings have been applied to the alloys of steel, copper and aluminum. Some ductile contents added to the powder enable the essential plastic deformation process.

Cold spray processes have been developed for further improving the corrosion resistance and the other essential functional capabilities of metals and composites used in different critical applications. It has been observed that the normal thermal spray techniques result in coatings with inferior functional properties compared to properties shown by parent materials. The thermal processes may suffer due to inclusions, in-flight oxidation, as well as re-melting at high temperatures, resulting in the onset of early corrosive deterioration due to interconnected porosity. Cold spray creates effective coatings with capabilities closer to the properties of parent metals. Corrosion and wear-resistant materials such as tungsten carbide can be cold sprayed on a variety of material surfaces.

Cold sprays produce coatings with advantages of very low porosity combined with a higher hardness compared to thermal sprays. They ensure a stronger substrate adhesion as well as cohesion of the particles, creating a stronger surface. A comparatively thinner cold spray coating can be as effective as the thicker thermal spray coating for providing corrosion protection and wear resistance.

Cold sprays of aluminium alloys, titanium, niobium and nickel alloys, and aluminum-tin alloy have potential applications as anti-corrosive coatings. The cold spray process results in higher Brinell hardness and lower oxygen content in the coat. It can be formed on complex geometric shapes with simple arrangement.

In some embodiments the post is a fence post. In other embodiments, the post is a trellis post. In yet other embodiments, the post can be another post type used in agriculture. Although this specification may refer to fence posts, it is to be appreciated that, context permitting, the description may equally apply to trellis posts or possibly other post types used in agriculture.

A trellis post means, for the purpose of this specification, any steel or alloy post being either solid or hollow in section or a comination of solid and hollow sections that is manufactured by any suitable method including being hot rolled, cold rolled, roll formed, extruded, stamped, molded or cast whereby the said post performs the function of suspending linear strand/s of any suitable material above the ground surface for the purpose of training vines or plants on the linear strand/s for the production of fruit or vegetables and most especially trellis posts used for viticulture.

One or more apertures, openings, slots or slits may be located in the non-ground anchoring region of the fence or trellis post. Herein, these will be referred to as ‘post member attachment points’, ‘fence member attachment points’, ‘trellis member attachment points’, ‘post member attachment regions’, ‘fence member attachment regions’ or ‘trellis member attachment regions’. One or more retainers, clips or other fence member types may be mounted to the non-ground anchoring region at the post/fence/trellis member attachment points or region.

In some embodiments, the at least one additional coat/coating is only applied to the ground anchoring region of the post. In some embodiments, the at least one additional coat/coating is also applied partway along the non-ground anchoring region of the post, immediately adjacent the ground anchoring region. In some embodiments, the at least one additional coat/coating is also applied to a limited region of the non-ground anchoring region of the post, immediately adjacent the ground anchoring region. In some embodiments, the at least one additional coat/coating is also applied to a region extending between a post/fence/trellis member attachment point (situated closest to the ground anchoring region) and the ground anchoring region. In some embodiments, the at least one additional coat/coating is also applied so as to extend from the ground anchoring region to a point beyond a post/fence/trellis member attachment point (situated closest to the ground anchoring region). In some embodiments, the at least one additional coat/coating extends from the ground anchoring region to approximately 5, 10, 15, 20, 25, 30, 35, 40, 45, or 50 mm beyond a post/fence/trellis member attachment point (situated closest to the non-ground anchoring region). In some embodiments, the at least one additional coat/coating extends from the ground anchoring region to approximately 55, 60, 65, 70, 75, 80, 85, 90, 95, 100 mm or even further beyond a post/fence/trellis member attachment point (situated closest to the non-ground anchoring region).

To extend the total corrosion resistance and potential working life of a post by increasing the corrosion protection coating along the entire length of said post adds additional and unnecessary cost if the sole purpose of the entire coating along the entire length of the post is to achieve an extended life for the ground anchoring region of the post. The general idea is to provide extended corrosion protection to the ground anchoring region of the post by way of at least one further coat/coating to the region of the post located within the ground, and not to the major region of the post that is located above the ground (ie. non-ground anchoring region). Preferably, the additional corrosion protection afforded by the at least one additional coating/coat extends along the entire ground anchoring region of the post as well as partway along the non-ground anchoring region, preferably up to a maximum of about 50 mm above the (first) post/fence/trellis member attachment point. This includes all about 1 mm increments up to about 50 mm. As mentioned, the post/fence/trellis member attachment region can be an opening, slot, keeper, or retainer in or on any surface of the post.

The at least one additional coating/coat can be a sacrificial coat/coating or a non-sacrificial (passive/barrier) coat/coating. Two or more additional coatings/coats can be used. For example, if two additional coatings/coats are used then these can be: first and second sacrificial coats/coatings; first and second non-sacrificial coats/coatings; a first sacrificial coat/coating and a second non-sacrificial coat/coating (top coat/top coating); or a first non-sacrificial coat/coating and a second sacrificial coat/coating (top coat/top coating).

The at least one additional sacrificial coating can be of any suitable composition. Examples of suitable sacrificial coatings include those described above, such as zinc, aluminium, zinc-aluminium alloy, zinc-nickel alloy, steel, titanium, copper, nickel, stainless steel, tin, nickel-chromium, acrylates, waxes, clear polymers and biopolymers. These can be applied to the post as described above. Alternatively, the at least one additional sacrificial coating can be applied by way of the following process: the ground anchoring region can undergo a surface preparation step (e.g. such as washing and/or scrubbing); the ground anchoring region can undergo a drying step (e.g. air drying); and the ground anchoring region can undergo a coating step (e.g. such as spray coating). These steps can be performed in-line, such as using a conveyor.

The at least one additional non-sacrificial coating can be of any suitable nature, and may be conductive or non-conductive, and may contain single polymers, or copolymers or a combination of polymers, copolymers and metals and especially coatings that are impervious to moisture and more especially impervious to water and oxygen. Examples of suitable non-sacrificial coatings/passive barriers include those described above, such as organic coatings, paints, epoxy resins, bitumin, thermoplastics, rubber coatings, plastics, ceramic coatings, and shrinkable sleeves.

These coatings can be applied to the post as described above. Alternatively, the at least one additional non-sacrificial coating can be applied by way of the following process: the ground anchoring region can undergo a surface preparation step (e.g. such as washing and/or scrubbing, etching or abrasive blasting); the ground anchoring region can undergo a drying step (e.g. using air drying); and the ground anchoring region can undergo a coating step (e.g. such as spray coating). These steps can be performed in-line, such as using a conveyor or roller system.

A problem with only having a passive coating is that when a breach occurs in the coating, the underlying metal substrate has no other corrosion protection present to slow down the corrosion. By having a combination of a non-sacrificial outer coating/outer passive barrier (impervious membrane) over the surface of a (zinc-aluminium sacrificial second coating (middle layer) with a hot galvanised innermost coating/layer bonded to the parent material, this is the ultimate protection system coating for extending the corrosion resistance of the ground anchoring region of a post.

In some embodiments, the steel or alloy post can have two sacrificial coatings. For example, an ungalvanised steel or alloy post (usually being black untreated steel) can first be coated with zinc (eg. by way of hot dipped galvanisation or electro-galvanisation), and then with a further coating of zinc, aluminium or zinc-aluminium alloy (eg. by way of thermal or cold spraying). In some embodiments posts can be alloy or aluminium and can have at least one additional coating applied to the ground anchoring region.

The method can comprise the step of cleaning or etching a coat/coating, and drying the etched or cleaned surfaces prior to applying the at least one additional coat.

The method can comprise the step of removing impurities from a coat/coating prior to applying the at least one additional coat.

The method can comprise the step of cleaning at least the ground anchoring region of the post (without removing any existing sacrificial or non-sacrificial coating) prior to applying the at least one additional coating.

The method can comprise the step of preparing the surface of the ground anchoring region of the post (and part of the non-ground anchoring region, if relevant) without removing a a significant portion or percentage of the existing coating, prior to applying the at least one additional coating.

The step of preparing the surface of the ground anchoring region (and part of the non-ground anchoring region, if relevant) to receive the additional coat/coating can be carried out in any suitable way. The preparation can comprise pickling, mechanical cleaning and/or other chemical treatment, and drying said surfaces.

The method can comprise the step of subjecting the post to acid treatment (pickling), washing, physical abrasion or ultrasonic cleaning so as to remove contaminants and promote formation of a passive film on the surfaces of the post (but in a very controlled way so as not to remove the existing coating).

Preferably, the step of cleaning does not damage or substantially reduce the coating on the non-ground anchoring region that is located above ground height when the post has been installed.

Preferably, the step of cleaning does not substantially reduce the thickness of the at least one sacrificial coating on the ground anchoring region.

The method can comprise the step of cleaning the surface to be coated without the removal of the existing coating, then heating at least the ground anchoring region of the post (and part of the non-ground anchoring region, if relevant). Any suitable temperature and heating time can be used.

The method can comprise the step of curing at least the ground anchoring region of the post (and part of the non-ground anchoring region, if relevant). Any suitable temperature and time can be used.

In some embodiments, once prepared, at least the ground anchoring region of the post (and part of the non-ground anchoring region, if relevant) can be heated to a temperature of between about 150 and 350° C. or between about 150 and 450° C. At least one additional non-sacrificial coat can then be applied by dipping the ground anchoring region of the post (and part of the non-ground anchoring region, if relevant) into a fluidised bed of powder for approximately 2 to 7 seconds. The dipped post can then be removed and cured at a temperature of approximately 150 to 190° C.

In some embodiments, once cleaned without removing a substantial portion of the coating, an electrostatic powder coating step can be used to coat the ground anchoring region of the post (and part of the non-ground anchoring region, if relevant) with the at least one additional coating. The post with the at least one newly added powder coated region can then be heated to between about 130 and 220° C.—either along its entire length or just the region of the post that received the at least one additional coating.

Any of the method steps mentioned in this specification can be performed in-line at different stations, such as using a conveyor to convey the post from one station to the next (eg. washing station, scrubbing station, drying station, spraying station).

Preferably, the steel or alloy post is an agricultural steel or alloy fence post, commonly referred to as a picket, T or Y post. The fence post can be of any suitable size, shape and construction. In some embodiments the fence post is T or Y-shaped when viewed in end elevation, having three lobes/arms/blades/flanges extending radially/laterally from a central longitudinal axis. Suitable fence post designs are shown in Australian design numbers 347267, 331130, 331129 and 321730, the entire contents of which are incorporated herein by way of reference.

Preferably more than one post is subjected to the method at any one time. That is, two, three, four, five, six, seven, eight, nine, 10, 11, 12, 13, 14, 15, 16, 17, 18, 19, 20, 21, 22, 23, 24 or more posts can be subjected to the steps of the method at any one time.

In some embodiments the coated steel or alloy post comprises coatings in the following order:

either an innermost sacrificial coating or innermost non-sacrificial coating immediately adjacent to the post parent material and extending along an entire length of the post;

either a first additional sacrificial coating or first additional non-sacrificial coating atop the innermost coating, extending along the ground anchoring region and preferably further partway along the non-anchoring region (as discussed elsewhere in this specification); and, optionally,

either a second additional sacrificial coating or second additional non-sacrificial coating atop the first additional coating, extending along the ground anchoring region and preferably further partway along the non-anchoring region (as discussed elsewhere in this specification).

Preferred embodiments of the method and/or post are described below.

Preferably the post is a fence or trellis post. The post is made of steel or metal alloy. The at least one coating is a sacrificial coating. The sacrificial coating comprises zinc, aluminium, zinc-aluminium alloy, zinc-nickel alloy, steel, titanium, copper, nickel, stainless steel, tin, nickel-chromium, acrylate, wax, clear polymer or a biopolymer. The sacrificial coating is applied by way of the following process steps: the ground anchoring region is subjected to a surface preparation step; the ground anchoring region is subjected to a drying step; and, the ground anchoring region is subjected to a coating step. The process steps are performed in-line using a conveyor or roller system. The sacrificial coating comprises zinc that has bound metallurgically with the steel. The sacrificial coating is applied by HVOF (High Velocity Oxy-Fuel Spraying), combustion flame spraying, plasma spraying, vacuum plasma spraying, or two wire electric arc spraying. The sacrificial coating is applied by spray transfer. The sacrificial coating is produced by thermal (arc or flame) spraying. The sacrificial coating is a powder coating applied electrostatically. The sacrificial coating is a liquid coating applied using a dipping step.

The at least one coating is a non-sacrificial coating. The non-sacrificial coating is conductive or non-conductive. The non-sacrificial coating is impervious to moisture. The non-sacrificial coating is impervious to water and oxygen. The non-sacrificial coating comprises an organic coating, paint coating, epoxy resin coating, bitumin coating, thermoplastic coating, rubber coating, plastic coating, ceramic coating, or shrinkable sleeve. The non-sacrificial coating comprises single polymers, copolymers or a combination of polymers, or copolymers and metals. The non-sacrificial coating is applied by way of the following process steps: the ground anchoring region is subjected to a surface preparation step; the ground anchoring region is subject to a drying step; and the ground anchoring region is subjected to a coating step. The process steps are performed in-line using a conveyor. The non-sacrificial coating is a thermoplastic coating and the thermoplastic coating is applied as a liquid or powder. The non-sacrificial coating is a protective coating that forms a tight barrier to prevent exposure to oxygen, water and salt. The non-sacrificial coating comprises a two-pack epoxy coating or chlorinated rubber coating. The non-sacrificial coating is cold sprayed onto the post. The cold spray comprises aluminium alloy, titanium alloy, niobium alloy, nickel alloy, or aluminum-tin alloy.

The at least one coating thickness is from about 15 to about 25 micrometers (0.6 to 0.8 mils). The post/fence/trellis member attachment point comprises an opening, slot or slit.

The at least one coating comprises a non-sacrificial outer coating covering a sacrificial second coating, which in turn coats a hot galvanised innermost coating of the steel or alloy post. The sacrificial second coating comprises zinc-aluminium.

The steel or alloy post comprises two sacrificial coatings. The ungalvanised steel or alloy post is first coated with zinc, and then with a further coating of zinc, aluminium or zinc-aluminium alloy.

The method comprises the step of cleaning or etching a coating, and drying the etched or cleaned coating surfaces prior to applying the at least one additional coat. The method comprises the step of removing impurities from a coating prior to applying the at least one additional coat. The method comprises the step of cleaning the at least the ground anchoring region of the post prior to applying the at least one additional coating. The method comprises the step of preparing the surface of the ground anchoring region of the post, and part of the non-ground anchoring region, if relevant, without removing any existing coating, prior to applying the at least one additional coating. The method comprises the step of subjecting the post to acid treatment, washing, physical abrasion or ultrasonic cleaning so as to remove contaminants and promote formation of a passive film on surfaces of the post. The method comprises the step of cleaning the surface to be coated without the removal of the existing coating, then heating at least the ground anchoring region of the post (and part of the non-ground anchoring region, if relevant). The method comprises the step of curing at least the ground anchoring region of the post (and part of the non-ground anchoring region, if relevant).

At least the ground anchoring region of the post (and part of the non-ground anchoring region, if relevant) is heated to a temperature of between approximately 150 and 350° C. or between about 150 and 450° C., at least one additional non-sacrificial coat is applied by dipping the ground anchoring region of the post (and part of the non-ground anchoring region, if relevant) into a fluidised bed of powder, and the dipped post is removed and cured at a temperature of approximately 150 to 190° C.

The coated steel or alloy post comprises coatings in the following order: either an innermost sacrificial coating or innermost non-sacrificial coating extending along an entire length of the post; either a first additional sacrificial coating or first additional non-sacrificial coating atop the innermost coating, extending along the ground anchoring region and preferably further partway along the non-anchoring region; and, optionally, either a second additional sacrificial coating or second additional non-sacrificial coating atop the first additional coating, extending along the ground anchoring region and preferably further partway along the non-anchoring region. Aelectrostatic powder coating step is used to coat the ground anchoring region of the post (and part of the non-ground anchoring region, if relevant) with the at least one additional coating, and the post with the at least one newly added powder coated region is heated to between about 130 and 220° C. All process steps are performed in-line at different stations, using a conveyor to convey the post from one station to the next, such as a washing station, scrubbing station, drying station and/or spraying station.

In extreme environments, such as but not limited to windy coastlands, areas around power stations or other situations where atmospheric conditions are extremely corrosive, the non-ground anchoring region of the post can be subjected to accelerated degradation due to corrosion. The inventor has also found that by applying to the entire length of the post at least one additional coat/coating (and more preferably two additional coats/coatings), such coat(s)/coating(s) being either sacrificial or non-sacrificial, this can extend the corrosion protection of the entire length of the post.

According to a ninth aspect of the present invention, there is provided a method of extending the corrosion resistance of a steel or alloy post already having a sacrificial coating or non-sacrificial coating along an entire length of the post, said method comprising the step of applying at least one additional coating to the entire length of the post so as to extend the corrosion resistance of the entire length of the post.

According to a tenth aspect of the present invention, there is provided a method of extending the corrosion resistance of a steel or alloy post, said method comprising the steps of:

applying a sacrificial coating or non-sacrificial coating along an entire length of the post; and

applying at least one additional coating to the entire length of the post so as to extend the corrosion resistance of the entire length of the post.

According to an eleventh aspect of the present invention, there is provided a method of producing a coated steel or alloy post adapted to have extended corrosion resistance, said method comprising the step of applying at least one additional coating to an entire length of a steel or alloy post already having a sacrificial coating or non-sacrificial coating extending along the entire length of the post.

According to a twelfth aspect of the present invention, there is provided a method of producing a coated steel or alloy post adapted to have extended corrosion resistance, said method comprising the steps of:

applying a sacrificial coating or non-sacrificial coating along an entire length of a steel or alloy post; and

applying at least one additional coating to the entire length of the post.

According to a thirteenth aspect of the present invention, there is provided a coated steel or alloy post when produced according to the method of the ninth, tenth, eleventh or twelfth aspect of the invention.

According to a fourteenth aspect of the present invention, there is provided a coated steel or alloy post having a sacrificial coating or non-sacrificial coating extending along an entire length of the post, and at least one additional coating applied to the entire length of the post.

The invention according to the ninth to fourteenth aspects can, context permitting, have features as described for the other aspects. That is features of products and methods as described for the other aspects apply in respect of the invention according to the ninth to fourteenth aspects.

The inventor has also found that the coating methodology can be used to extend the working life of an aluminium post.

According to a fifteenth aspect of the present invention, there is provided a method of extending the corrosion resistance of a ground anchoring region of an aluminium post having a natural coating of aluminium oxide, said method comprising the step of applying at least one additional coating to the ground anchoring region so as to extend the corrosion resistance of the ground anchoring region.

According to a sixteenth aspect of the present invention, there is provided a method of producing a coated aluminium post adapted to have extended corrosion resistance, said method comprising the step of applying at least one additional coating to a ground anchoring region of an aluminium post having a natural coating of aluminium oxide.

According to a seventeenth aspect of the present invention, there is provided a coated aluminium post when produced according to the method of the fifteenth or sixteenth aspect of the invention.

According to an eighteenth aspect of the present invention, there is provided a coated aluminium post having a natural coating of aluminium oxide, and at least one additional coating applied to a ground anchoring region of the post.

According to a nineteenth aspect of the present invention, there is provided a coated aluminium post having a natural coating of aluminium oxide having a ground anchoring region and a non-ground anchoring region, wherein the ground anchoring region comprises at least one additional coating that does not extend beyond the ground anchoring region or extends from the ground anchoring region partway along the non-ground anchoring region.

The aluminium post can be a fence or trellis post as described elsewhere in this specification. The invention according to the fifteenth to nineteenth aspects can, context permitting, have features as described for the other aspects. That is features of products and methods as described for the other aspects apply in respect of the invention according to the fifteenth to nineteenth aspects.

Having broadly described the invention in its various embodiments, non-limiting examples of embodiments will now be given.

### BRIEF DESCRIPTION OF FIGURES

FIG. 1 illustrates various coated steel agricultural posts (i to xxx), produced according to methods of the present invention.

FIG. 2 is a flow chart depicting how steel agricultural fence posts are usually manufactured.

FIG. 3 is a flowchart depicting the manufacture of coated steel fence posts, according to various embodiments of the present invention.

FIG. 4 is a flowchart depicting the manufacture of coated steel fence posts, beginning with galvanised fence posts, according to an embodiment of the present invention.

FIG. 5 is a flowchart depicting the manufacture of coated steel fence posts, beginning with galvanised fence posts, according to an embodiment of the present invention.

FIG. 6 depicts an in-line method for preparing, drying and applying an additional sacrificial coating or non-sacrificial coating to a fence post, according to an embodiment of the present invention.

### BEST MODES FOR CARRYING OUT THE INVENTION

Although this Best Modes section mostly describes fence posts, it is to be understood that, context permitting, this section may equally apply to trellis posts or other steel or alloy post types used in agriculture. It may also apply to aluminium posts.

The inventor has found that powder coated or passive coated (painted) posts provide no further corrosion protection to the steel substrate once the surface is broken through or breached. Zinc coatings (active/sacrificial coatings) on posts start working from the moment they are placed in the ground. By adding at least one additional non-porous/impervious membrane or coating over the zinc coated posts their “life sacrificing actions” are delayed from commencing—and may never be called upon to start sacrificing should the impervious barrier never be breached. By adding a third coating that offers an even longer sacrificial lifespan (zinc-aluminium alloy, for example), that middle coating will only ever be “called up for service” to start sacrificing only if the outermost coating is breached.

Again, the inventor has discovered that the working life of an agricultural steel or alloy post having a sacrificial coating or non-sacrificial coating extending along an entire length of the post can be extended by increasing corrosion protection to the ground anchoring region of the post. This is achieved by applying at least one additional coat/coating of a sacrificial and/or non-sacrificial (passive/barrier) nature to the ground anchoring region. Preferably, in the case of a fence post, the at least one additional coat/coating is further applied to/extends from the ground anchoring region to approximately 50 mm beyond a first fence member attachment point/region (situated closest to the ground anchoring region).

In some preferred embodiments, a fully galvanised fence post further has at least one additional sacrificial and/or non-sacrificial (passive/barrier) coating applied to its ground anchoring region. Preferably, the at least one additional coat/coating is further applied to/extends from the ground anchoring region to approximately 50 mm beyond a first fence member attachment point/region (situated closest to the ground anchoring region).

In other preferred embodiments, a fence post having a length-long passive coating further has at least one additional sacrificial and/or non-sacrificial (passive/barrier) coating applied to its ground anchoring region. Preferably, the at least one additional coat/coating is further applied to/extends from the ground anchoring region to approximately 50 mm beyond a first fence member attachment point/region (situated closest to the ground anchoring region).

In yet other preferred embodiments, a sacrificial coating or non-sacrificial coating is first applied to the entire length of a previously untreated steel fence post, and then at least one additional sacrificial and/or non-sacrificial (passive/barrier) coating is then applied to the ground anchoring region of the treated fence post. Preferably, the at least one additional coat/coating is further applied to/extends from the ground anchoring region to approximately 50 mm beyond a first fence member attachment point/region (situated closest to the ground anchoring region).

Referring first to FIG. 2, that figure depicts how agricultural steel fence posts are usually produced. Black untreated steel posts are: manufactured 2 and may or may not contain fence member attachment points. The posts are further processed so as to incorporate holes, openings, slots or other types of fence member attachment points 3. The posts are then prepared by way of pickling, mechanical cleaning, ultrasonic cleaning or other suitable preparation treatment 4. The posts are then hot dipped galvanised and subjected to passivation-quenching treatment 5. Finally, the posts are assembled and packaged for sale 6.

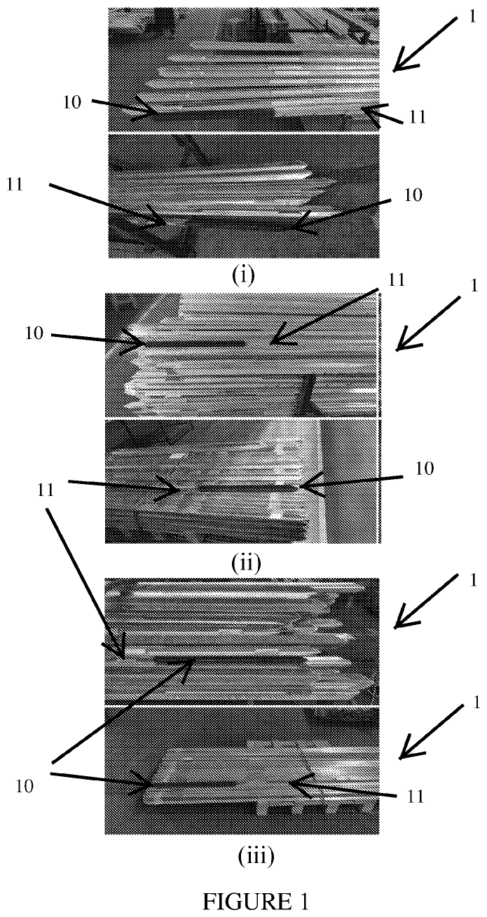

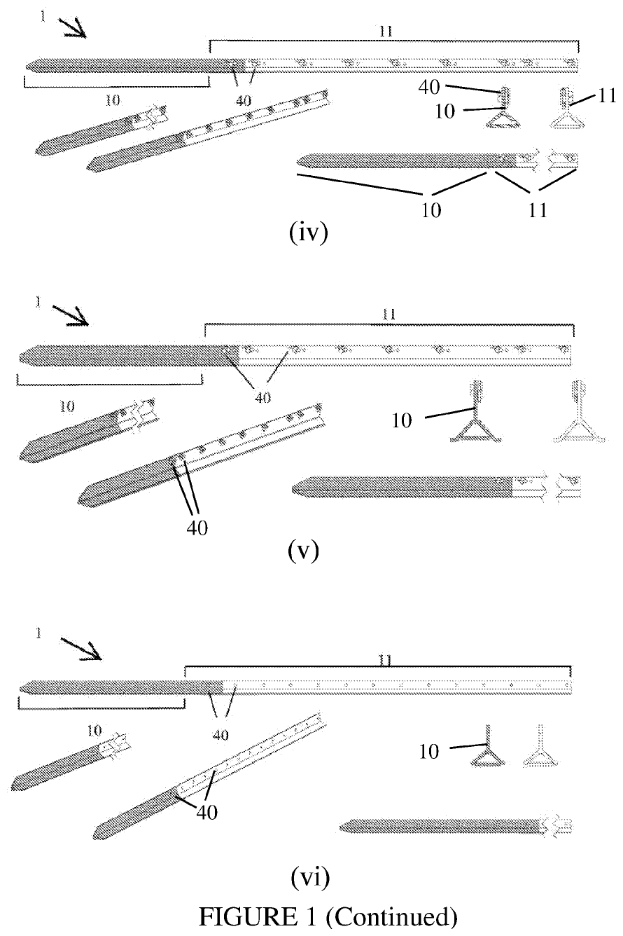

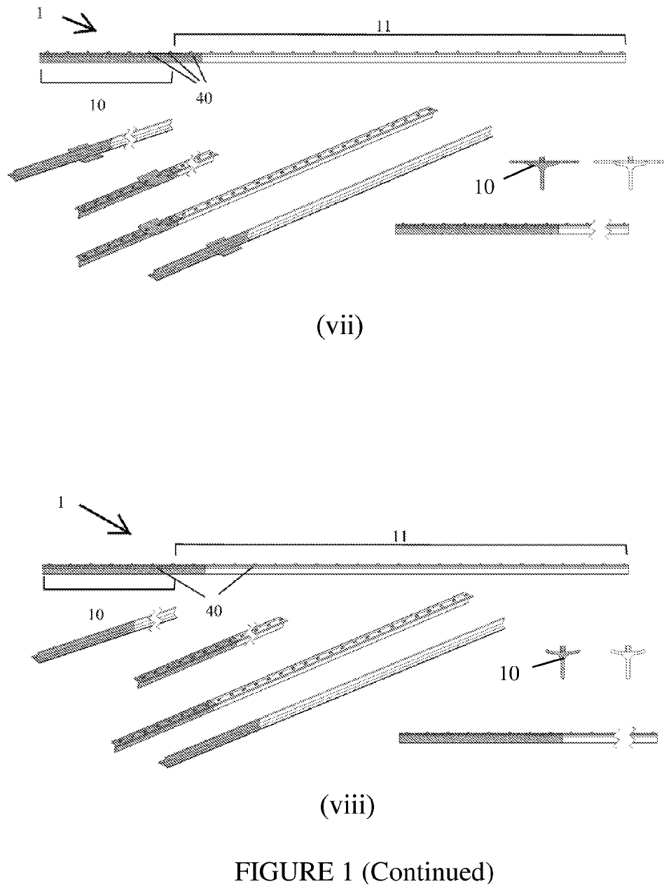

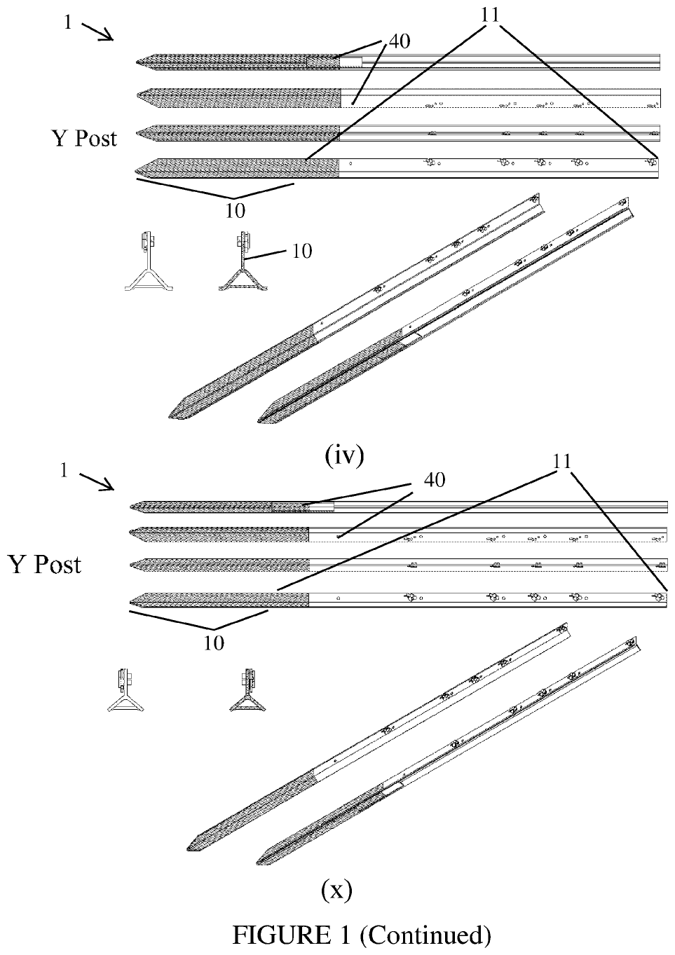

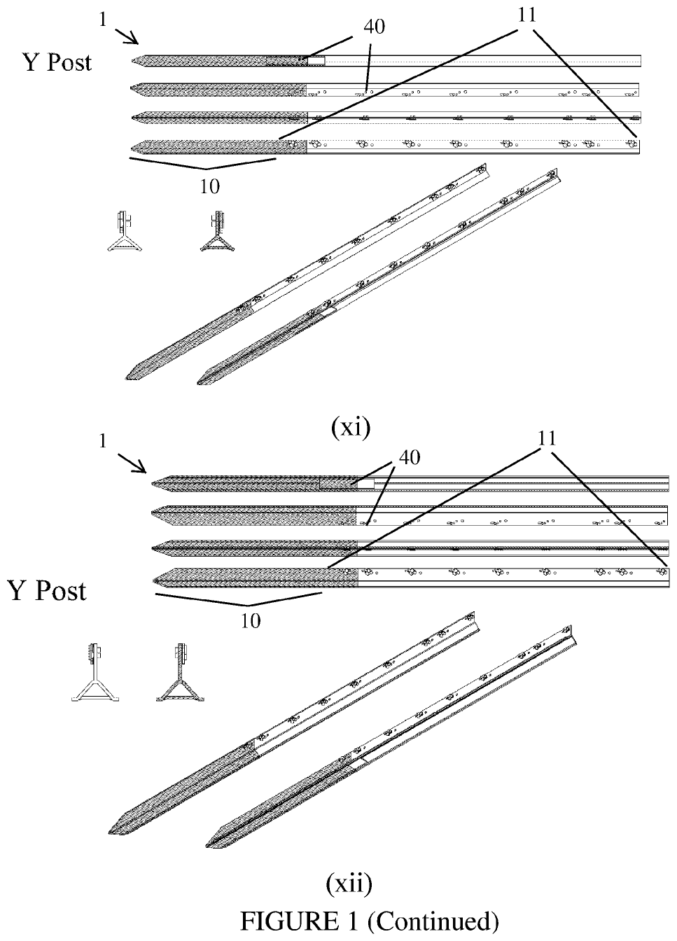

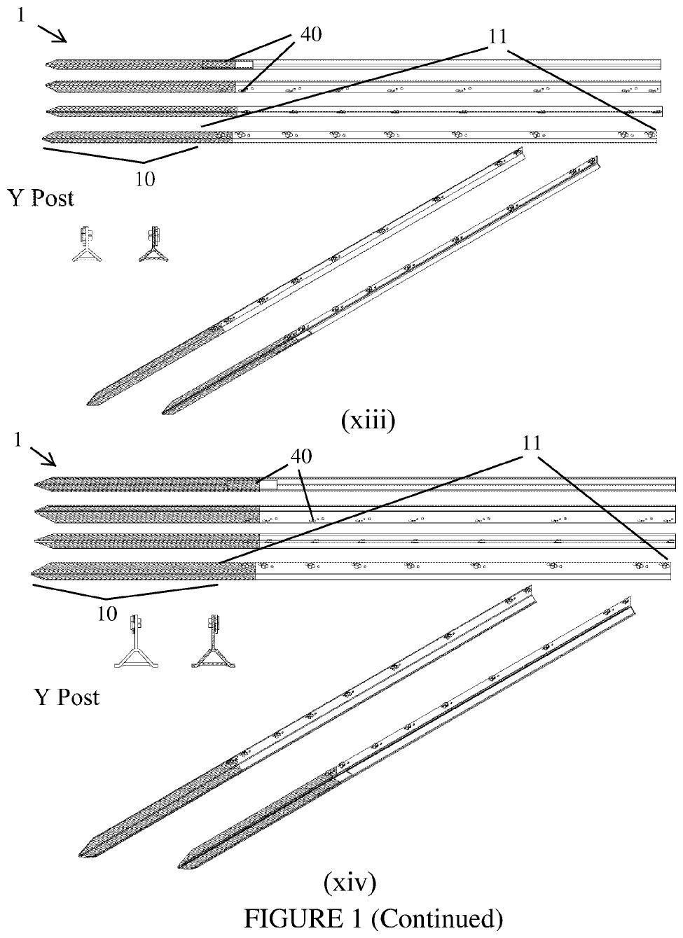

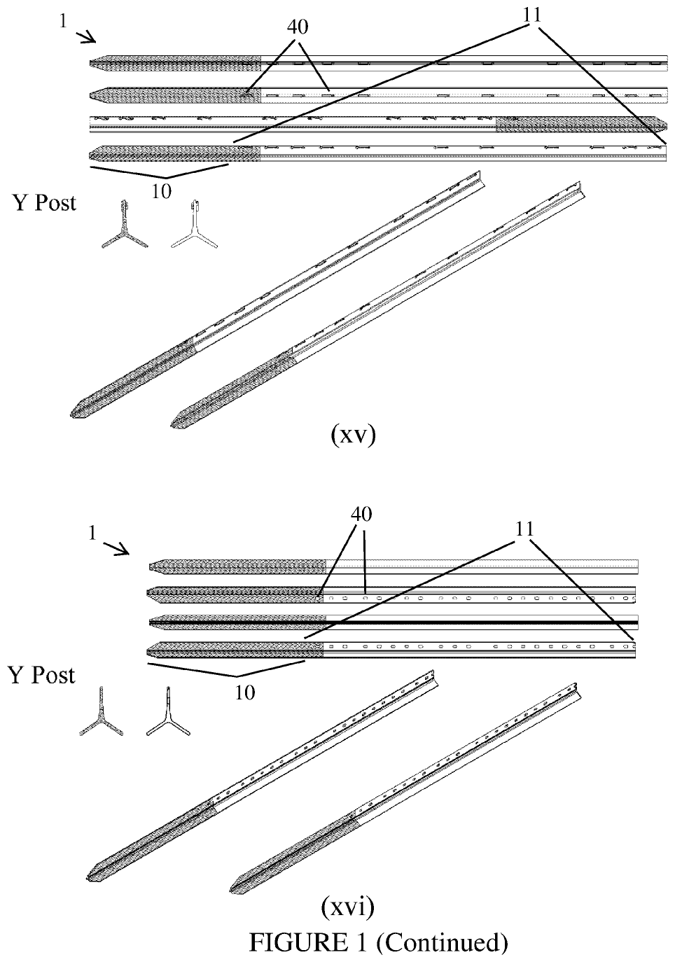

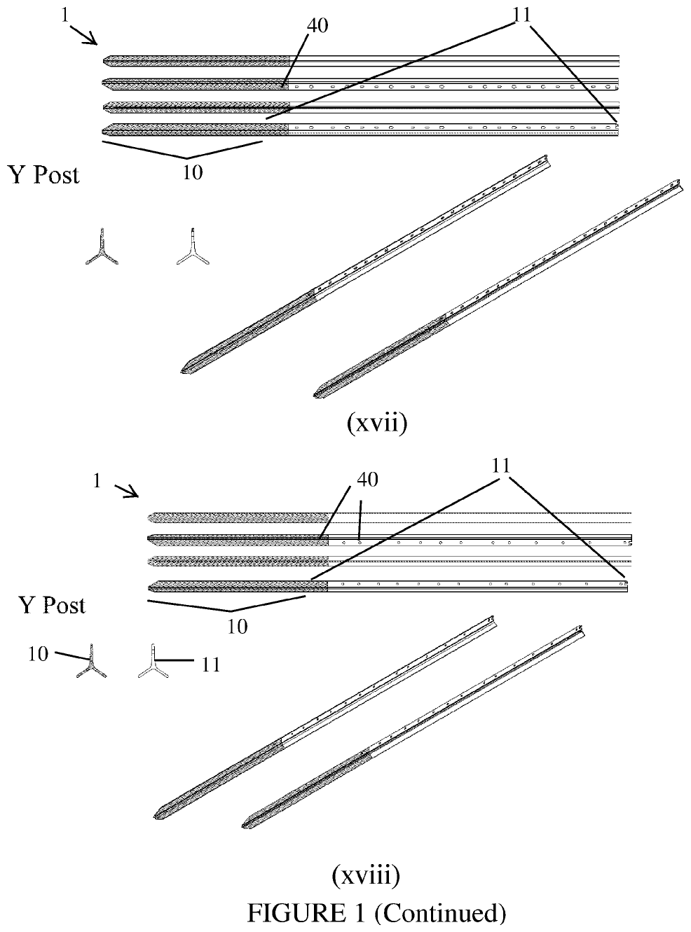

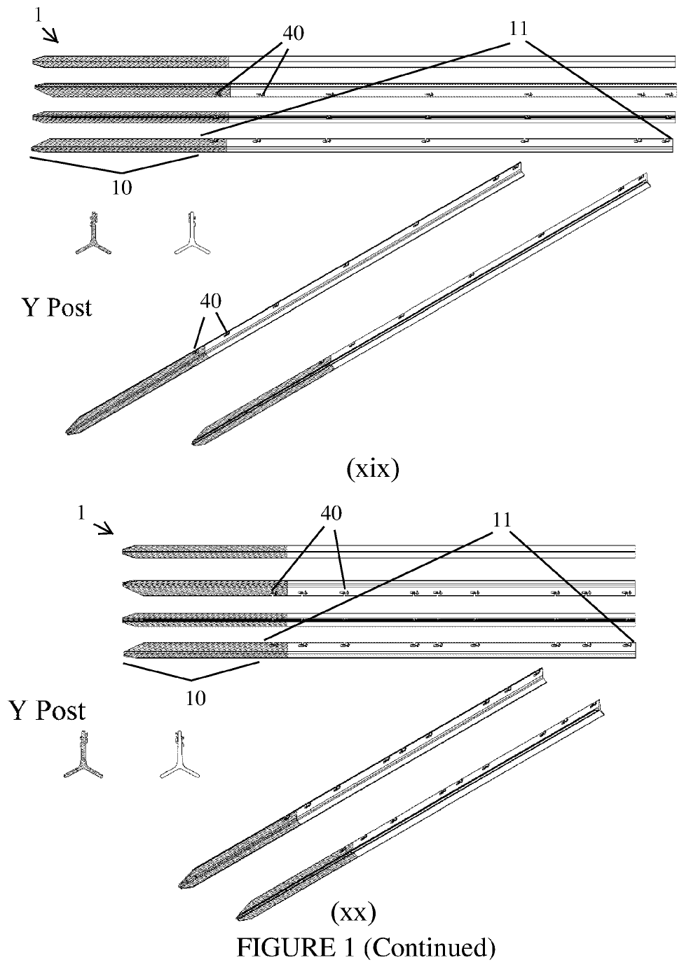

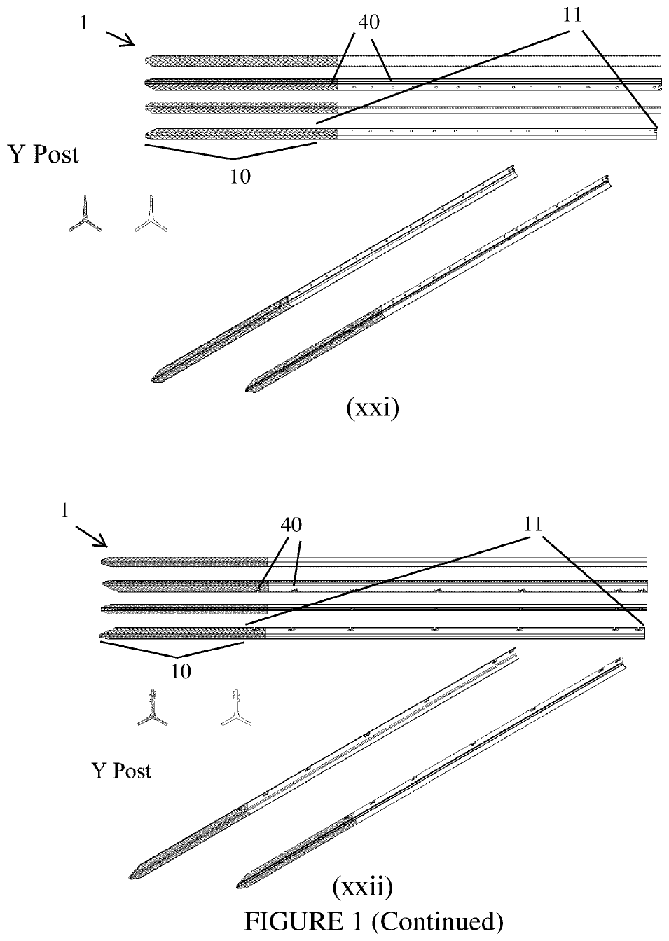

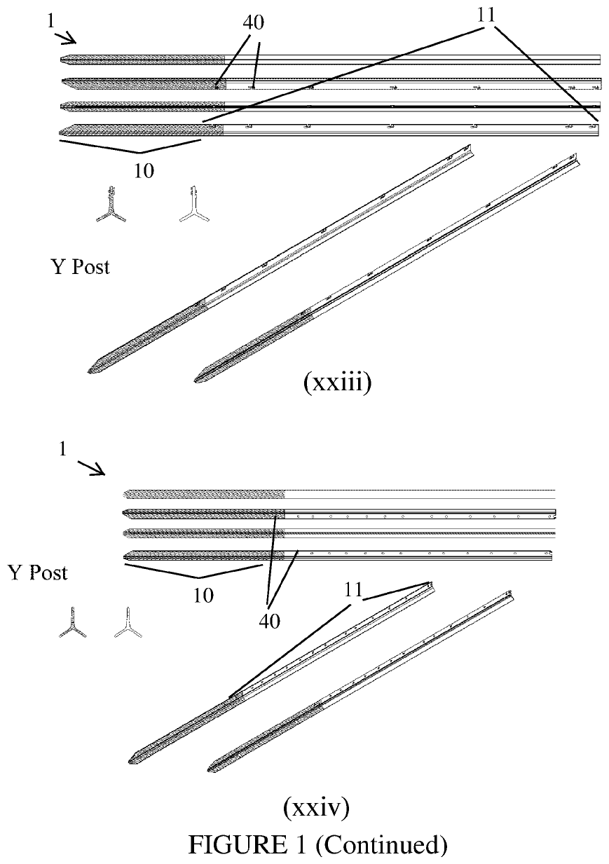

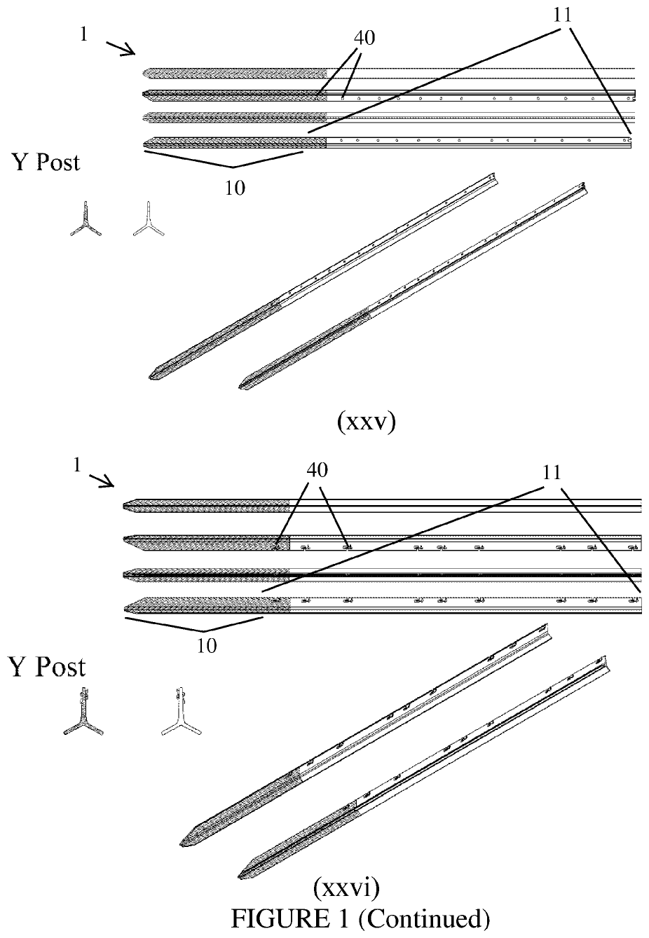

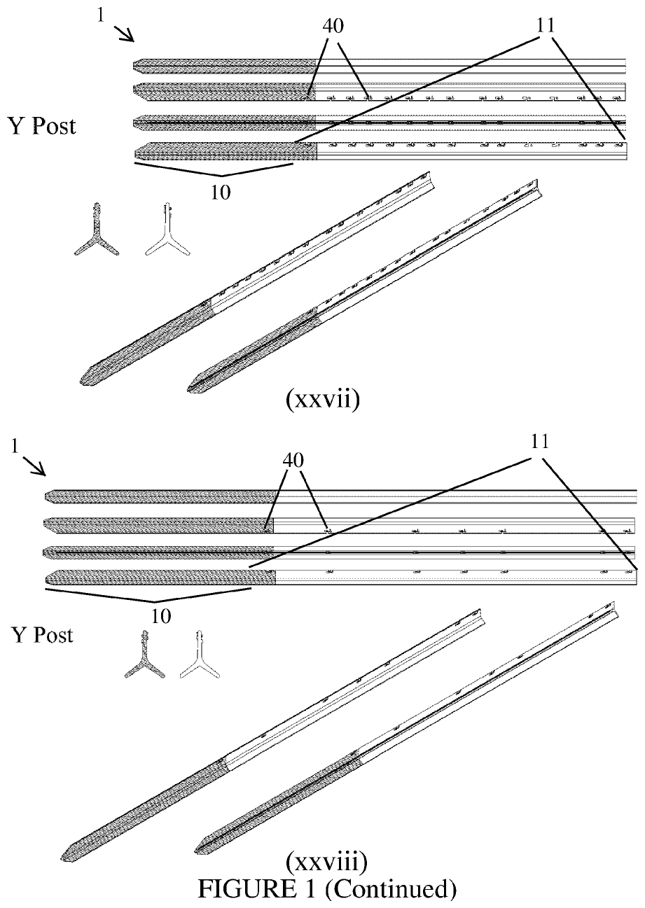

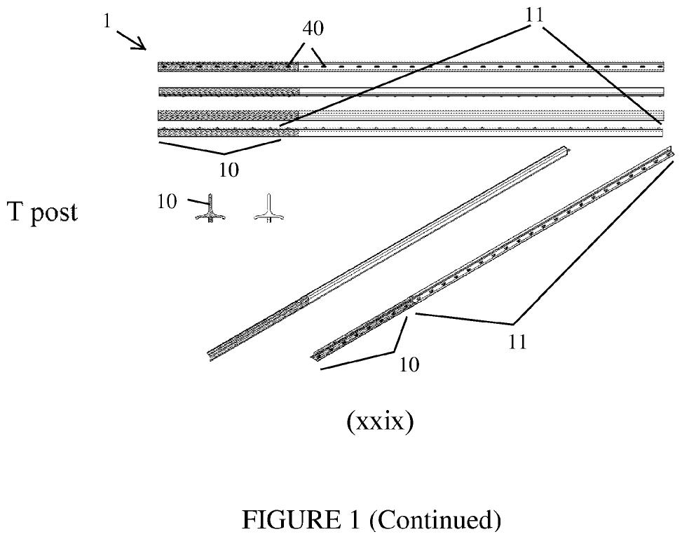

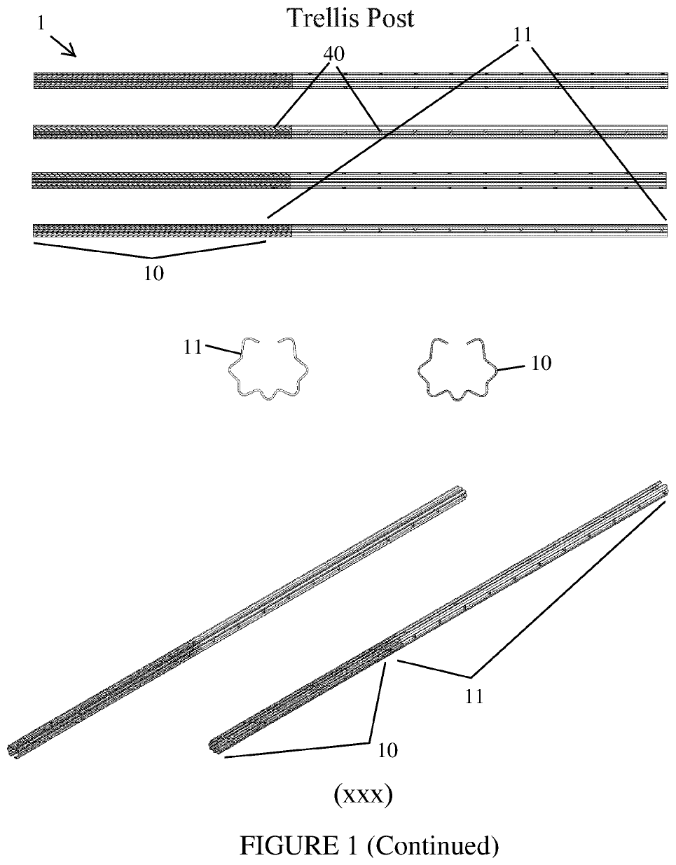

As seen in FIG. 1, each post 1 (i to xxx) has a ground anchoring region 10 and a non-ground anchoring region 11. Each post 1 usually has one or more fence member anchoring points 40 located along the non-ground anchoring region 11. To these are mounted clips, retainers, wires and other types of fence members/accessories.

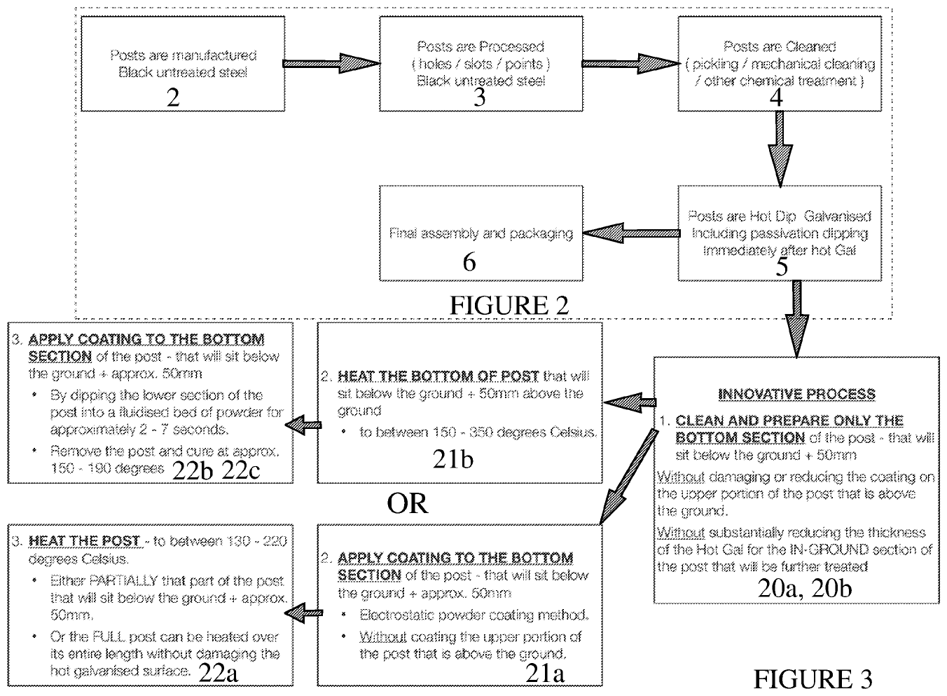

Referring now to FIGS. 3, 4 and 5, each of those figures depicts the present innovative process according to embodiments of the present invention. First, a galvanised post 1a, 1b having a sacrificial coating is suitably prepared for further treatment. In particular, the ground anchoring region 10a, 10b of the post 1a, 1b plus an adjacent short region of the non-ground anchoring region 11a, 11b (approximately 50 mm above a first fence member attachment point/region) are suitably prepared without damaging or reducing the existing sacrificial coating on the non-ground anchoring region 11a, 11b that is located above the ground, and without substantially reducing the thickness of the sacrificial coating on the ground anchoring region 10a, 10b.

After the step of suitable preparation 20b, according to a first embodiment (also depicted in FIG. 5), the ground anchoring region 10b plus an adjacent short region of the non-ground anchoring region 11b (approximately 50 mm above a first fence member attachment point/region) are heated to a temperature between about 150° and 350° C. 21b, following which the ground anchoring region 10b plus the adjacent short region of the non-ground anchoring region 11b are dipped into a fluidised bed of secondary coating material for approximately 2-7 seconds 22b. The post 1b is then removed and cured at approximately 150 to 190° C. 23b. In this way, a coated post 1b is produced, as shown in FIG. 1.

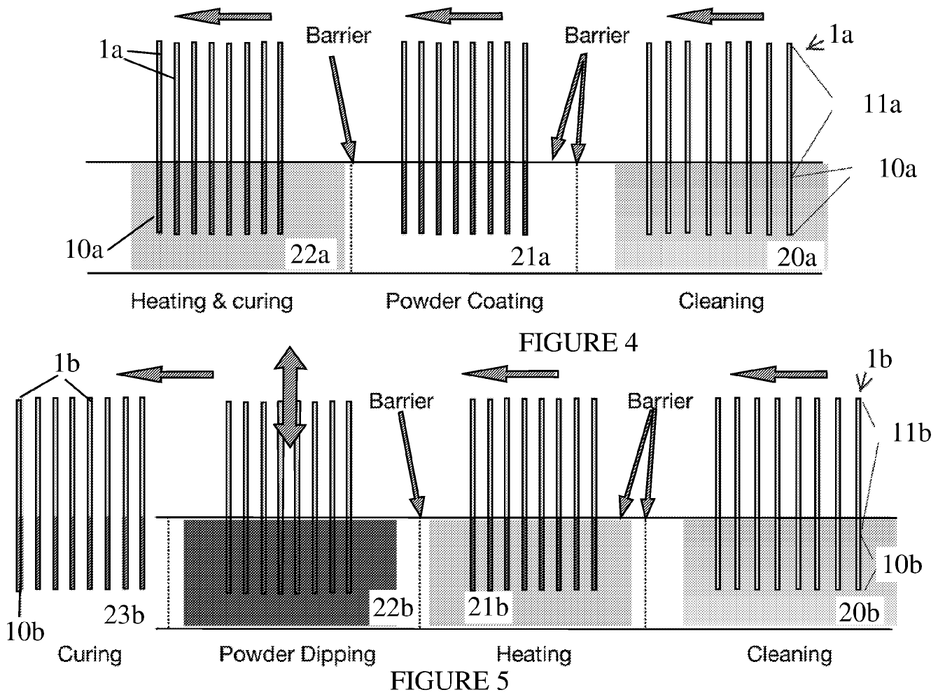

After the step of suitably preparing the posts 20a, according to a second embodiment (also depicted in FIG. 4), the ground anchoring region 10a plus an adjacent short region of the non-ground anchoring region 11a are subjected to an electrostatic powder coating step 21a. The post 1a (all of the post 1a or just the ground anchoring region 10a plus the adjacent short region of the non-ground anchoring region 11a) is heated to between about 130 and 220° C. 22a. In this way, a coated post is produced 1a, as shown in FIG. 1.

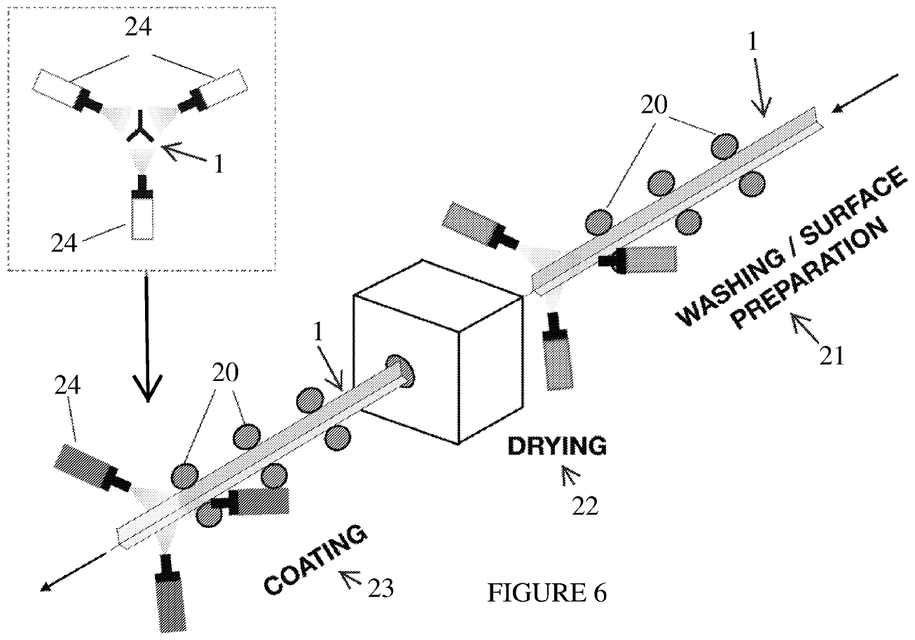

FIG. 6 shows an in-line method for preparing, drying and applying an additional sacrificial coating or non-sacrificial coating to a fence post 1, according to an embodiment of the present invention. The method utilises rollers 20 of a conveyor which convey the fence post 1 through a washing/surface preparation station 21, a drying station 22, and a spray coating station 23. The coating station 23 has spray nozzles 24 that are able to coat all surfaces of the fence post 1.

Advantages of the present invention as exemplified include: that the corrosion resistance of a ground anchoring region of a steel agricultural post can be extended, thereby potentially increase the working life of the whole post; and, that this can be achieved in a cost effective manner.

Throughout this specification, unless in the context of usage an alternative interpretation is required, the term “comprise” (and variants thereof such as “comprising” and “comprised”) denotes the inclusion of a stated integer or integers but does not exclude the presence of another integer or other integers.

Any reference to publications cited in this specification is not an admission that the disclosures constitute common general knowledge in Australia or in other countries.

It will be appreciated by one of skill in the art that many changes can be made to the composition and uses exemplified above without departing from the broad ambit and scope of the invention.

1. (canceled)

2. (canceled)

3. (canceled)

4. (canceled)

5. (canceled)

6. A coated steel or alloy post comprising a sacrificial coating or non-sacrificial coating extending along an entire length of the post, and comprising at least one additional coating on a ground anchoring region of the post; wherein the post is a fence post that is T or Y-shaped when viewed in end elevation.

7. The coated steel or alloy post of claim 6, wherein the post has a ground anchoring region and a non-ground anchoring region, wherein the sacrificial coating or non-sacrificial coating is a galvanized coating, and wherein the ground anchoring region comprises the at least one additional coating which does not extend beyond the ground anchoring region or extends from the ground anchoring region partway along the non-ground anchoring region.

8. The coated steel or alloy post of claim 6, wherein the post has a ground anchoring region and a non-ground anchoring region, and wherein the ground anchoring region comprises the at least one additional coating which does not extend beyond the ground anchoring region or extends from the ground anchoring region partway along the non-ground anchoring region.

9. (canceled)

10. (canceled)

11. The post of claim 8, wherein a small region of the non-ground anchoring region of the post, immediately adjacent the ground anchoring region comprises the at least one additional coating.

12. The post of claim 8, wherein the non-ground anchoring region comprises at least one post member attachment point, and wherein the non-ground anchoring region comprises the at least one additional coating on a region extending said between at least one post member attachment point, situated closest to the ground anchoring region, and the ground anchoring region.

13. The post of claim 12, wherein the non-ground anchoring region comprises the at least one additional coating on a region extending from the ground anchoring region to a point just beyond the at least one post member attachment point, situated closest to the ground anchoring region.

14. The post of claim 13, wherein the at least one additional coating extends from the ground anchoring region to approximately 50 mm beyond the at least one post member attachment point, situated closest to the non-ground anchoring region.

15. (canceled)

16. (canceled)

17. (canceled)

18. (canceled)

19. (canceled)

20. The post of claim 6, wherein the at least one additional coating extends along the entire length of the post.

21. (canceled)

22. The post of claim 6, wherein the post is a steel fence post.

23. The post of claim 6, wherein the at least one additional coating is a sacrificial coating.

24. The post of claim 23, wherein the sacrificial coating comprises zinc, aluminium, zinc-aluminium alloy, zinc-nickel alloy, steel, titanium, copper, nickel, stainless steel, tin, nickel-chromium, acrylate, wax, clear polymer or a biopolymer.

25. (canceled)

26. (canceled)

27. The post of claim 6, wherein the at least one additional coating is a non-sacrificial coating.

28. The post of claim 27, wherein the non-sacrificial coating is conductive or non-conductive.

29. The post of claim 27, wherein the non-sacrificial coating is impervious to moisture; or wherein the non-sacrificial coating is impervious to water and oxygen.

30. (canceled)

31. The post of claim 27, wherein the non-sacrificial coating comprises an organic coating, paint coating, epoxy resin coating, bitumin coating, thermoplastic coating, rubber coating, plastic coating, ceramic coating, or shrinkable sleeve.

32. The post of claim 27, wherein the non-sacrificial coating comprises single polymers, copolymers or a combination of polymers, or copolymers and metals

33. (canceled)

34. (canceled)

35. The post of claim 6, wherein the at least one coating comprises a non-sacrificial outer coating covering a sacrificial second coating, which in turn coats a hot galvanised innermost coating of the post.

36. (canceled)

37. The post of claim 6, wherein the post comprises two sacrificial coatings.

38. The post of claim 37, wherein an ungalvanised steel or alloy post is first coated with zinc, and then with a further coating of zinc, aluminium or zinc-aluminium alloy.

39. (canceled)

40. (canceled)

41. The post of claim 6, wherein the post is an agricultural post.
